(19) United States
(12) Patent Application Publication
(10) Pub. No.: US 2016/0148305 A1
(43) Pub. Date: May 26, 2016

(54) MOVEMENT BASED SHOPPING

(71) Applicant: eBay Inc., San Jose, CA (US)

(72) Inventor: Sergio Pinzon Gonzales, San Jose, CA (US)

(21) Appl. No.: 14/555,149

(22) Filed: Nov. 26, 2014

(51) Int. Cl. G06Q 30/06; H04W 4/02

(52) U.S. Cl. CPC G06Q 30/0641; H04W 4/028

(57) ABSTRACT

Systems and methods are disclosed herein include a method for inferring the state of a user of a mobile device based on the movement of the mobile device. A method is provided that includes receiving, at a computer system, movement data from a mobile device through a network interface, the movement data comprising data specifying the movement of the mobile device over a period of time; determining, at the computer system, a shopping state of a user of the mobile device based on the movement data; selecting a plurality of products from a database of available products to present to the user based on the shopping state of the user, and providing, through the network interface, a listing of the plurality of products to the mobile device.

### FIELD

This disclosure relates generally to movement based shopping.

### BACKGROUND

The ever-increasing use of smart phones, such as the iPhone™ and Android™ based phones with data connections and location determination capabilities is slowly changing the way people interact, shop for products and services, and even manage accounts. Smart phones can provide users with nearly instant information regarding a wide range of information, such as product availability, friend locations, or pricing. For example, applications such as RedLaserT (from eBay, Inc. of San Jose, Calif.) allow a smart phone user to scan a bar code and instantly check prices across online and local retail outlets. Smart phones also commonly include mechanisms, such as global positioning system (GPS) receivers, that allow the devices to constantly update location information. These technology changes are also driving changes in the way people wish to interact with mobile devices within different contextual locations (e.g., retail stores, at home, or at school).

### BRIEF DESCRIPTION OF THE FIGURES

These and other features, aspects, and advantages of the present disclosure are better understood when the following Detailed Description is read with reference to the accompanying drawings.

FIG. 1 illustrates an example architecture in which a representative user may use a mobile device 105 to interact with a server according to some embodiments described herein

FIG. 2 illustrates a block diagram of the mobile device according to some embodiments described herein.

FIG. 3 illustrates a block diagram of the server according to some embodiments described herein.

FIG. 4 illustrates block diagrams of the data that comprise user information database, the product listing database, and the advertisement database according to some embodiments described herein.

FIG. 5 illustrates an example path of a user in a mission-based shopping state moving through a shopping area according to some embodiments described herein.

FIG. 6 illustrates an example path of a user in a discovery-based shopping state moving through the shopping area according to some embodiments described herein.

FIG. 7 illustrates an example path of a user in a research-based shopping state moving through the shopping area according to some embodiments described herein.

FIG. 8 illustrates an example path of a user in a herd-based shopping state moving through the shopping area according to some embodiments described herein.

FIG. 9 is a flowchart of an example process of using the shopping state of a user to provide a listing of products on a mobile device according to at least one embodiment described herein.

FIG. 10 is a flowchart of an example process of using the shopping state of a user to provide a listing of products on a mobile device according to at least one embodiment described herein.

### DETAILED DESCRIPTION

Systems and methods are disclosed that use movement data of a mobile device to determine a shopping state of a user of the mobile device. A listing of products (e.g., goods, services) and/or advertisements may be selected based on the movement data and provided to the user via a user interface. The movement data may include the speed and/or direction of the user over a period of time. The movement data may also include geolocation data specifying the geographic location of the mobile device.

In some embodiments, content in place of, as part of, or in addition to a listing of products or advertisements can be selected based on the movement data of the mobile device and provided to a the user through the mobile device. In some embodiments, the nature of the content, the length of the content, the type of content, whether the content includes text, visual (e.g., image, video), and/or audio, whether the content includes a photo or a video, the digital file size of the content, the size or color of the font included with the content, the rate of play of the content (e.g., beats per minute), features of the content, or some combination thereof may be selected, configured, and/or changed based on the movement data.

In some embodiments, the movement data may be used to restrict access to some content or restrict access to some features of some applications. For example, the movement data may identify an inebriated, medicated, or tired state of the user (e.g., rapid changes in speed and/or direction of the user device). Based on this state of the user, the user may be restricted from making certain types of purchases, communicating with certain contacts (e.g., clients, employers, former lovers), communicating in certain ways (e.g., texting, calling, emailing), accessing an automobile or driving an automobile, automatically calling, texting or emailing a contact, or some combination thereof.

In some embodiments, the movement data may be used to change the function of one or more applications on the mobile device. For example, if it is determined that the user is driving an automobile (e.g., if the speed of the mobile device is greater than 25 mph), based on the movement data, the mobile device may limit certain functions like texting, emailing, web browsing, etc. The mobile device, for example, may also limit access to some applications. As another example, the mobile device may also change the function or user interface of a mobile application.

As another example, if it is determined that the user is riding a bicycle (e.g., if the speed (or average speed) of the mobile device is greater than about 8 mph but less than about 25 mph), functions of the mobile device and/or one or more application on the mobile device may be changed according to a bicycle riding state.

As another example, if it is determined that the user is running or jogging (e.g., if the speed (or average speed) of the mobile device is greater than about 4 mph but less than about 8 mph), functions of the mobile device and/or one or more application on the mobile device may be changed according to a running state.

As another example, if it is determined that the user is walking (e.g., if the speed (or average speed) of the mobile device is greater than about 2 mph but less than about 4 mph), functions of the mobile device and/or one or more application on the mobile device may be changed according to a walking state.

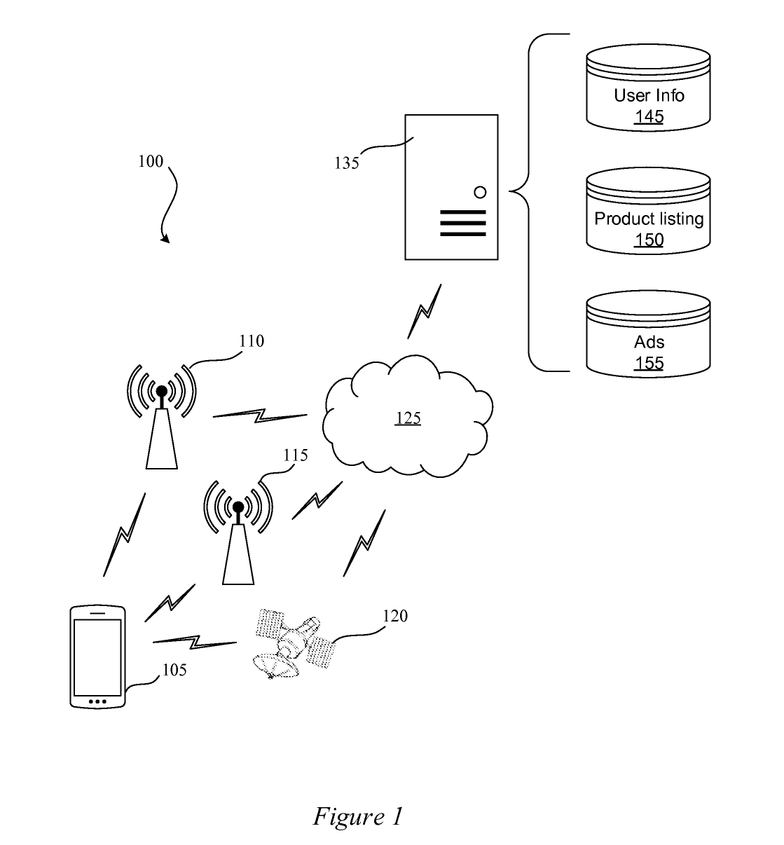

FIG. 1 illustrates an example architecture 100 in which a user may use a mobile device 105 to interact with a server 135. The mobile device 105 may be implemented as any number of mobile devices, including but not limited to a mobile phone, a smartphone, a smartwatch or other wearable computing device, a tablet, a personal digital assistant (PDA), a laptop computer, a net book, an eBook reader, a personal media player, a portable gaming system, an automobile navigation system, and so forth. The mobile device 105 may be location aware, or is able to provide information to another entity (e.g., a server) to allow the other entity to determine a location of the mobile device 105.

The geolocation of the mobile device may be a location on the surface of the Earth. The geolocation be provided to the device by a satellite 120 such as a GPS satellite. Alternatively or additionally, wireless signals such as from a radio antenna 110 or a Wi-Fi hotspot 115 may be used to determine a geolocation of the mobile device 105 relative to a known position of the radio antenna 110. The geolocation of the mobile device 105 may also be determined relative to one or more Bluetooth beacons. Other technologies and methods for determining geolocation are also envisioned within the scope of this disclosure.

The mobile device 105 and the server 135 may communicate via the network 125. The network 125 may include any one or combination of multiple different types of networks, such as, for example, Bluetooth® communication networks or a cellular communications network for sending and receiving communications and/or data including via SMS, MMS, hypertext transfer protocol (HTTP), direct data connection, wireless application protocol (WAP), e-mail, etc. The network 125 may also include a mobile data network that may include third-generation (3G), fourth-generation (4G), long-term evolution (LTE), long-term evolution advanced (LTE-A), Voice-over-LTE (“VoLTE”) or any other mobile data network or combination of mobile data networks. Further, the network 110 may include one or more IEEE 802.11 wireless networks.

In some embodiments the satellite 120, the radio antenna 110, and/or the Wi-Fi hotspot 115 may provide network connectivity to the mobile device 105. For example, the radio antenna 110 may provide network access to the mobile device 105 according to the International Mobile Telecommunications-2000 standards (“3G network”) or the International Mobile Telecommunications Advanced standards (“4G network”).

In some embodiments, one or more servers may also be connected to the network 125 and configured to manage interaction between the mobile device 105 and the merchant 130. In some implementations, all or part of the interaction between the mobile device 105 and the merchant 130 may be through a direct communications link without passing through the server or the network 125. The direct communication link may be implemented by radio transmissions (e.g., IEEE 802.11, Bluetooth), infrared signals, radio frequency identification (RFID), magnetism (e.g., magnetic strips such as used on credit cards), display of a code on the mobile device 105 to a human operator or to a scanning device at the merchant 130, and/or any other method of directly passing information between the mobile device 105 and the merchant 130.

In some embodiments, the server 135 may house or otherwise have a connection to multiple data stores including user information database 145, a product listing database 150, an advertisement database 155, other data stores, or some combination thereof. In some embodiments, the user information database 145 may include information about the user associated with the mobile device 105. The user information database 145, for example, may enable efficient and personalized interaction between the user and the merchant. The product listing database 150, for example, may include information about one or more products or listing of products that can be displayed to the user. The advertisement database 155, for example, may include information about one or more advertisements that can be displayed to the user.

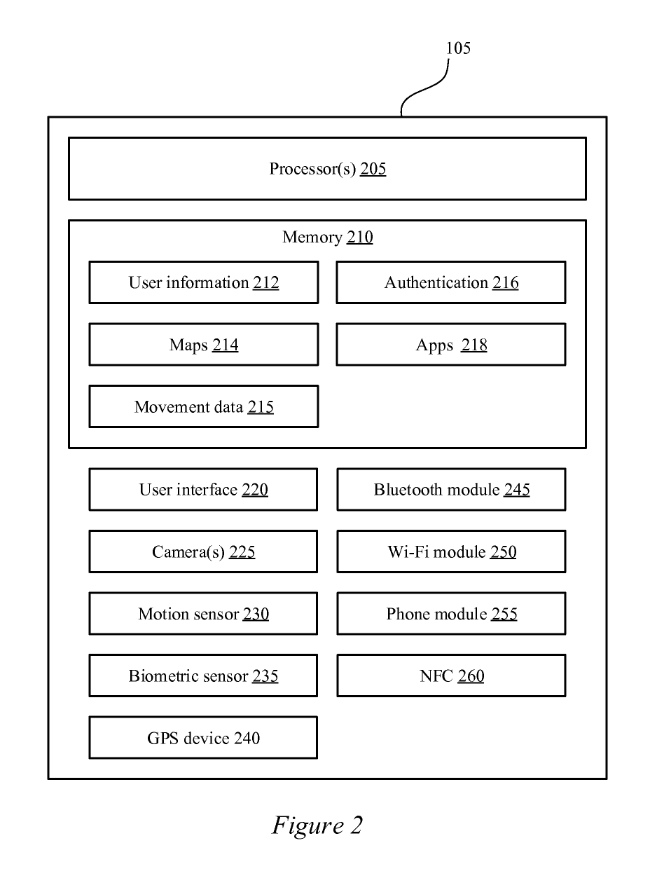

FIG. 2 illustrates a block diagram of the mobile device 105 according to some embodiments described herein. The mobile device 105 may include a processor 205, memory 210, user interface 220, camera 225, motion sensor 230, biometric sensor 235, GPS device 240, Bluetooth module 245, Wi-Fi module 250, phone module 255, NFC module 260, or some combination thereof. The mobile device 105 may include various other components or devices.

The processor 205 may include any type of processor such as, for example, a controller, microcontroller, control logic, a computer, a server, etc. The processor 205 may be electronically coupled with and/or control the operations of the user interface 220, camera 225, motion sensor 230, biometric sensor 235, GPS device 240, Bluetooth module 245, Wi-Fi module 250, phone module 255, and near field communication (NFC) module 260.

The processor 205 may be electronically coupled with and/or control the operations of the memory 210. In some embodiments, the memory may include applications, modules, or routines that may be executed by the process 205.

In some embodiments, the memory 210 may include, without limitation, a disk drive, a drive array, an optical storage device, a solid-state storage device, such as random access memory (“RAM”) and/or read-only memory (“ROM”), which can be programmable, flash-updateable, or some combination thereof.

The memory 210 may include user information 212, maps 214, movement data 215, authentication module 216, application 218, or some combination thereof.

In some embodiments, the memory 210 may include software elements or modules such as, for example, an operating system, one or more applications 218, or some combination thereof. The software elements or modules may include programs that may implement various embodiments described herein and/or may be designed to implement methods and/or configure systems of the present disclosure, as described herein. For example, one or more procedures described with respect to the method(s) discussed below might be implemented as code and/or instructions executable by the processor 205.

In some embodiments, the software elements or modules may take the form of executable code, which is executable by the processor 205 and/or might take the form of source and/or installable code, which, upon compilation and/or installation on mobile device 105 (e.g., using any of a variety of generally available compilers, installation programs, compression/decompression utilities, etc.), then takes the form of executable code.

In some embodiments, processor 205 may include user information 212 that may include a unique number or code that uniquely identifies each user of a plurality of mobile device of which mobile device 105 is included. In some embodiments, the user information 212 may include one or more user IDs and one or more passwords. In some implementations, the user information 212 may be entered by the user into the mobile device 105, such as, for example, during a setup procedure such as by entering a user name and a password. In other implementations, the user information 212 may be included in hardware of the mobile device 105. For example, a unique serial number of the mobile device 105 may be linked with a user name and password when the user purchases the mobile device 105. As a further example, a subscriber identification module (SIM) on a removable SIM card within the mobile device 105 may contain the user information 212. In this example, the user information 212 may be transferred between devices by moving the SIM card.

In some embodiments, the user information 212 may be associated with the user ID This user information 212 may be configurable by the user and can include payment information, a home location, historical geolocation data, past transaction histories, a user identification related to the merchant associated with the server 135, and/or any other information related to the user.

In some embodiments the memory 210 may include maps 214. Maps 214 may be downloaded to the mobile device from a remote server through the network 125. Various map services exist from which maps may be downloaded. These maps, for example, may include information specifying the identity, type, and/or the location of various stores based on geolocation.

In some embodiments the memory 210 may include movement data 215 as discussed in more detail below. The movement data 215 may also include a module, routine or application executable by the processor 2015 to derive or determine movement data from geolocation data and/or determine a state of the user of the mobile device based on the movement data.

In some embodiments the memory 210 may include authentication module 216. The authentication module 216 may be used to authenticate a user of the mobile device 105 and/or authenticate a user with the server 135. The authentication module 216, for example, may communicate with the authentication module 315 of the server 135. The authentication module 216 may include software, algorithms, or routines that may be executed by the processor 205 to perform various authentication functions with authentication data including authenticating a user with the mobile device and/or authenticating the mobile device and/or the user with the server 135.

In some embodiments the memory 210 may include applications (or apps) 218. The applications 218 may include shopping applications that may allow a user to view and purchase various items. The applications 218 may include a web browser that may be used to display and/or purchase various items. Any number and/or types of applications 218 may be included.

Some or all the applications 218, for example, may use movement data to determine the information or content that may be presented to a user of the mobile device 105. Some or all the applications 218, for example, may limit and/or change the user interaction of the application based on the movement data. In some embodiments, the application 218 may be configurable based on various factors such as, for example, the speed, direction, location, or some combination thereof of the mobile device and/or the state of the user of the mobile device.

The mobile device 105 may also include a user interface 220 that may, for example, include one or more displays, a touch screen display, one or more buttons, one or more keys, a keyboard, or some combination thereof. The user interface 220 may be communicatively coupled (either wirelessly or wired) with the processor 205 and/or the memory 210. In some embodiments, the user interface 220 and/or the processor 205 may be able to render webpages, documents, images, figures, etc. received from the server 135.

The user interface 220 such as, for example, a display, may be used to display a listing of products or advertisements to the user. The listing of products may be sent to the user in a number of formats. For example, a web page may be used to display the listing of products or an advertisement. As another example, an application (or app) may be used to display the listing of products or an advertisement. In some embodiments, the listing of products may include a renderable file provided by the server 135 that can be displayed by the user interface.

In some embodiments, in response to movement data sent to the server 135 form the mobile device 105, the server 135 may create a webpage or a renderable file. The server 135 may then send the webpage or the renderable file to the mobile device 105 when it is prepared. The server 135 may send either of these files in response to a request for the file from the mobile device 105, as part of a push notification, or in any other way.

In some embodiments, a communication channel via the network 125 may be established and opened between an application executing on the mobile device 105 and the server 135. In some embodiments, the webpage or the renderable file may be sent to the mobile device 105 through the communication channel and may be displayed to a user via the user interface 220.

In some embodiments, the mobile device 105 may include a camera 225. The camera may be communicatively coupled (either wirelessly or wired) with the processor 205 and/or the memory 210.

In some embodiments, the mobile device 105 may include a motion sensor 230. The motion sensor 230 may be communicatively coupled (either wirelessly or wired) with the processor 205 and/or the memory 210. The motion sensor 230 may include, for example, an accelerometer, gyroscope, and/or a magnetometer. The motion sensor 230 may include, for example, a nine-axis sensor that outputs raw data in three axes for each individual sensor: acceleration, gyroscope, and magnetometer, or it can output a rotation matrix that describes the rotation of the sensor about the three Cartesian axes. In some embodiments, the motion sensor 230 may provide acceleration data. The motion sensor 230 may be sampled with a sampling frequency and the motion data saved into the memory 210 as part of the movement data 215.

Alternatively, the motion sensor 230 may include separate sensors such as a separate one-, two-, or three-axis accelerometer, a gyroscope, and/or a magnetometer. In some embodiments, the separate sensors of the motion sensor 230 may provide acceleration data. The motion sensor 230 may be sampled with a sampling frequency and the motion data saved into the memory 210 as part of the movement data 215.

In some embodiments, the mobile device 105 may include a biometric sensor 235. The biometric sensor 235 may be communicatively coupled (either wirelessly or wired) with the processor 205 and/or the memory 210. The biometric sensor 235 may be used by a user for authentication of the identity of the user. The biometric device, for example, may include a fingerprint scanner. The authentication module 216 may use biometric data received from the biometric sensory 235 to authenticate a user with the Mobile device 105.

In some embodiments, the mobile device 105 may include a GPS device 240. The GPS device 240 may be communicatively coupled (either wirelessly or wired) with the processor 205 and/or the memory 210. The GPS device 240 may include a sensor that may collect GPS data. In some embodiments, the GPS data may be sampled and saved into the memory 210 at the same rate as the video frames are saved. Any type of the GPS sensor may be used. GPS data may include, for example, the latitude, the longitude, the altitude, a time of the fix with the satellites, a number representing the number of satellites used to determine GPS data, the bearing, and speed. The GPS device 240 may record GPS data into the memory 210. For example, the GPS device 240 may sample GPS data at a predetermined frequency such as, for example, 1 Hz, 0.1 Hz, 0.5 Hz, 0.01 Hz, etc. The GPS data may be saved into the memory 210 at the same rate. Geolocation data may include GPS data and/or additional data.

In some embodiments, GPS data that is older than a predetermined period of time may be deleted from memory 210. For example, GPS saved for over 1 hour, 2 hours, 5 hours, 10 hours, etc., may be deleted.

In some embodiments, the mobile device 105 may include a Bluetooth module 245. The Bluetooth module 245 may be communicatively coupled (either wirelessly or wired) with the processor 205 and/or the memory 210. The Bluetooth module 245 may include an antenna for communication with another Bluetooth enabled device. The processor 205 may send and receive data from another Bluetooth enabled device through the Bluetooth module 245. The Bluetooth module 245 may include logic that may convert data from the processor 205 into the proper communication protocol for communication with another Bluetooth enabled device. The logic may also convert data in a Bluetooth protocols received from another Bluetooth enabled device and communicate the data to the processor 205.

In some embodiments, the mobile device 105 may include a Wi-Fi module 250. The Wi-Fi module 250 may be communicatively coupled (either wirelessly or wired) with the processor 205 and/or the memory 210. The Wi-Fi module 250 may connect the mobile device 105, for example, with the network 125 via Wi-Fi hotspot 115. The Wi-Fi module 250 may establish a communication channel between the mobile device 105 and the server 135.

The Wi-Fi module 250 may include an antenna for communication with another Bluetooth enabled device. The processor 205 may send and receive data from another Wi-Fi enabled device through the Wi-Fi module 250. The Wi-Fi module 250 may include logic that may convert data from the processor 205 into the proper communication protocol for communication with another Wi-Fi enabled device. The logic may also convert data in a Wi-Fi protocol received from another Wi-Fi enabled device and communicate the data to the processor 205.

In some embodiments, the mobile device 105 may include a phone module 255. The phone module 255 may be communicatively coupled (either wirelessly or wired) with the processor 205 and/or the memory 210. The phone module 255 may connect the mobile device 105 with the network 125 via radio antenna 110 using a mobile phone network. The phone module 255 may include a communication channel between the mobile device 105 and the server 135.

In some embodiments the mobile device 105 may include a NFC module 260. The NFC device may be communicatively coupled (either wirelessly or wired) with the processor 205 and/or the memory 210.

In some embodiments, memory 210 may include movement data 215. The movement data 215, for example, may include motion data collected from the motion sensor 230, GPS data collected by GPS device 240, Wi-Fi location data inferred from communication with Wi-Fi hotspots, Bluetooth location data inferred from Bluetooth beacon location data, or some combination thereof. In some embodiments, the movement data 215 may include the speed of the mobile device 105 at specific point in time or an average period of time, the direction the mobile device 105 is heading at specific point in time or an average period of time, the geolocation of the mobile device 105 at specific point in time or an average period of time, or some combination thereof.

In some embodiments, the GPS data may be used to determine the speed and/or the direction of the mobile device 105. For example, the processor 205 may determine the speed and/or the direction of movement of the mobile device 105 by noting the change in GPS coordinates over time. Additionally or alternatively, the GPS device 240 may provide speed data and/or direction data that is stored as part of the movement data 215.

In some embodiments, the speed and/or direction of the mobile device 105 may be inferred from Bluetooth hotspot and/or Wi-Fi hotspot tracking data. For example, as the mobile device 105 moves it may connect with or interface with a first Bluetooth hotspot and/or a first Wi-Fi hotspot for a period of time and may receive the geolocation of the first Bluetooth hotspot and/or the first Wi-Fi hotspot. As the mobile device 105 moves away from the first Bluetooth hotspot and/or the first Wi-Fi hotspot the mobile device 105 may connect with a second Bluetooth hotspot and/or a second Wi-Fi hotspot. The mobile device 105 may receive the geolocation of the second Bluetooth hotspot and/or the second Wi-Fi hotspot. The speed and/or direction of the user may be determined from the geolocation data of the first Bluetooth hotspot and/or the first Wi-Fi hotspot and the geolocation data of the second Bluetooth hotspot and/or the second Wi-Fi hotspot. As the mobile device 105 continues to move it may continue to interface with Bluetooth hotspots and/or the Wi-Fi hotspots from which additional speed and/or direction data may be determined.

In some embodiments, the direction of the mobile device 105 may be determined from compass data included with the motion sensor 230. In some embodiments, the GPS data may be used to determine the direction of the user by noting the direction the mobile device 105 is moving relative to some coordinate system.

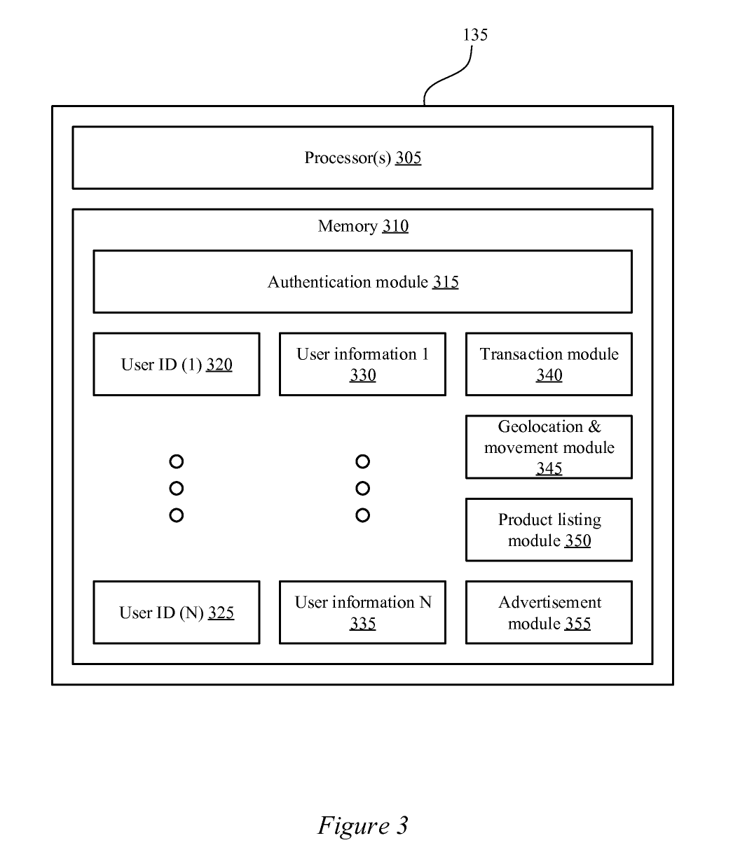

FIG. 3 illustrates a block diagram of the server 135 according to some embodiments described herein. The server 135 may include processor 305 and memory 310. In some embodiments, the server 135 may include one or more servers of various types that may be connected together via network 125.

The processor 305 may include any type of processor such as, for example, a controller, microcontroller, control logic, a computer, a server, etc. The processor 305 may be electrically coupled with and/or may control the operation of the memory 310, and various other components of the server 135 such as, for example, communication interfaces, other storage devices, etc.

In some embodiments, the memory 310 may include software elements or modules such as, for example, an operating system, authentication module 315, transaction module 340, geolocation and movement module 345, product listing module, 350, advertising module 355, or some combination thereof. The software elements or modules may include programs that may implement various embodiments described herein and/or may be designed to implement methods and/or configure systems of the present disclosure, as described herein. For example, one or more procedures described with respect to the method(s) discussed below might be implemented as code and/or instructions executable by the processor 305.

In some embodiments, the software elements or modules may take the form of executable code, which is executable by the processor 305 and/or might take the form of source and/or installable code, which, upon compilation and/or installation on server 135 (e.g., using any of a variety of generally available compilers, installation programs, compression/decompression utilities, etc.), then takes the form of executable code.

In some embodiments, the memory 310 may can include, without limitation, local and/or network-accessible storage and/or can include, without limitation, a disk drive, a drive array, an optical storage device, a solid-state storage device, such as random access memory (“RAM”) and/or read-only memory (“ROM”), which can be programmable, flash-updateable, or some combination thereof.

The authentication module 315 may be used to authenticate a user of the mobile device 105 with an associated user ID 320 and 325. In some embodiments, the authentication module may compare login information provided by the user through the mobile device 105 with login in information included with the authentication module (or with a third party system). Once authenticated, the user ID 320 may be identified along with the user information 330.

In some embodiments, the transaction module 340 may be used to consummate a transaction between the user using the mobile device 105 and the server 135. The user may select a product and enter payment and shipping information through the user interface 220 of mobile device 105. This information may be processed, authenticated, verified, etc. by the server 135 wither singularly or in combination with other servers.

In some embodiments, the geolocation and movement module 345 may include geolocation data for each mobile device associated with a user having a user ID. The geolocation data may include movement data, GPS data, location data, direction data, speed data, Bluetooth hotspot location data, Wi-Fi hotspot location data, time data, etc. as described herein. The movement module 345 may process geolocation data to infer the speed and/or the direction of the mobile device. In some embodiments, the movement module 345 may determine movement data based on geolocation data.

The product listing module 350 may include data stored in product listing database 150. In some embodiments, once a user ID has been identified and/or when the user associated with the user ID has been identified as in a shopping mode, product listings in the product listing database 150 may be identified and/or stored in the product listing module 350. In some embodiments, product listing module 350 may identify the products that may be listed based on the movement data and/or other data.

The advertisement module 355 may include data stored in product listing database 150. In some embodiments, once a user ID has been identified and/or when the user associated with the user ID has been identified as in a shopping mode, advertisements in the advertisement database 155 may be identified and/or stored in the advertisement module 355. In some embodiments, advertisement module 355 may identify the advertisements that may be listed based on the movement data and/or other data.

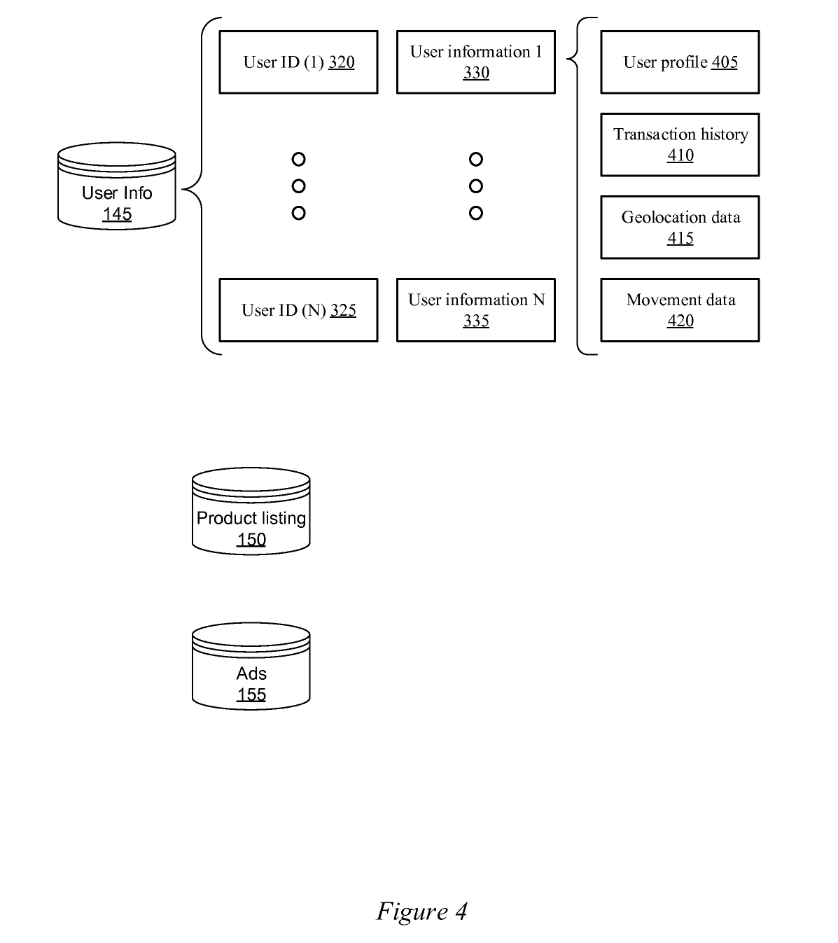

FIG. 4 illustrates block diagrams of the data that comprise user information database 145, the product listing database 150, and the advertisement database 155. The user information database 145, the product listing database 150, and/or the advertisement database 155 may be stored within the memory 310 of the server 135 or stored within other data storage locations.

The user information database 145 may include a plurality of user IDs 320 and 325. Each user ID 320 may be associated with specific user information 330 associated with the user ID 320. The user ID 320 may be associated with a user of one or more mobile device 105. In some embodiments, the authentication module 315 may determine the user ID associated with a user of the mobile device 105.

The user information 330 may include data regarding the user such as, for example, the user profile 405, the transaction history 410 of the user, geolocation data 415 associated with the mobile device 105, movement data 420 associated with the mobile device 105, or some combination thereof.

The user profile 405 may include information about the user including the user's name, address, password, username, birthdate, etc.

In some embodiments, the transaction history 410 of the user may include a listing of the transactions that the user associated with the user ID has engaged in in the past.

The transaction history 410 of the user associated with the user ID may also include information predicting the type of transactions or products the user may choose to enter into in the future. A prediction engine (e.g., executed by processor 305) may use the transaction history to predict products that will likely be of interest to the user associated with the user ID and/or may be presented to the user associated with the user ID through the mobile device 105.

In some embodiments, geolocation data 415 may include the past location of the user associated with the user ID, the current geolocation data of the user associated with the user ID, the movement data of the user associated with the user ID. In some embodiments, the geolocation data may be associated with the transaction data. In this way, for example, the geolocation of the user may be used to predict future products that will likely be of interest to the user associated with the user ID.

In some embodiments, the movement data 420 may include the speed and/or direction of the user associated with the user ID over time. The movement data 420 may be associated with the geolocation data. The movement data 420 may be used to determine a shopping state of the user of the mobile device 105. The shopping state of the user may then be used, in conjunction with the transaction history to select a plurality of product listing(s) or advertisements to present to the user through the mobile device 105.

In some embodiments, the movement data may expire, be disregarded, be ignored, or some combination thereof after a period of time has elapsed such as, for example, after two hours, three hours, four hours, five hours, six hours, eight hours, nine hours, etc. In some embodiments, the movement data may expire, be disregarded, be ignored, or some combination thereof when geolocation data associated with the mobile device indicates that the mobile device is no longer near a shopping area (e.g., within a predetermined number of miles from a previously visited shopping area). In some embodiments, the movement data may expire, be disregarded, be ignored, or some combination thereof when the mobile device accelerates at a rate indicative of a transition between walking and driving a car. For example, when the speed changes from less than 3 mph to over 20 mph.

The product listing database 150 may include a plurality of products that may be listed to users based on any number of factors. Each product in the product listing database 150 may include information associating each product with various factors that may be used to identify which product from the product listing database 150 may be presented to the user. These factors may include, for example, the user's shopping state, the user's geolocation, the time of year, the time of month, the time of day, user information, movement data, or some combination thereof.

The advertisement database 155 may include a plurality of advertisements that may be listed to users based on any number of factors. Each advertisement in the advertisement database 155 may include information associating each advertisement with various factors that may be used to identify which advertisement from the advertisement database 155 may be presented to the user. These factors may include, for example, the user's shopping state, the user's geolocation, the time of year, the time of month, the time of day, user information, movement data, or some combination thereof.

Various shopping states may be used to determine the products and/or advertisements that may be provided to the user through the mobile device 105. These may include, for example, a mission-based shopping state, a discovery-based shopping state, a herd-based shopping state, a research-based shopping state, or any other shopping state that may be determined based on the speed and/or the direction of the user through a shopping area or over a period of time.

A mission-based shopping state of a user may be indicated by a mobile device 105 moving directly between a few points of interest. For example, a user in a mission-based shopping state may be only interested in purchasing a few known items. The user, for example, may be on a mission to purchase these items and may not be interested in anything else. As such, the user may enter a shopping area or store solely to find and purchase this item.

A mission-based shopping state can be determined, for example, based on the speed of the mobile device 105 as the user moves between points of interest. For example, if the mobile device 105 moves at a speed that is more than the average walking speed of the user or the average walking speed of a shopper in the specific location then the user may be considered to be in a mission-based shopping state.

A mission-based shopping state may also be determined, for example, based on the number of times the mobile device 105 stops for a period of time at a point of interest. For example, a user may be in a mission-based shopping state if the user stops at only a single point of interest, two points of interest, three points of interest, or four points of interest in a given period of time, in a general geographical area, or some combination thereof.

A mission-based shopping state may also be determined, for example, based on mobile device spending a predetermined period of time at a location known to be a help desk, include a map of a shopping area, include a directory, or some combination thereof. A mission-based shopping state may also be determined, for example, if the mobile device moves toward a location of a sales associate that is either mobile or stationary. A mobile sales associate, for example, may be tracked via GPS or with other geolocation tracking schemes. A user of a mobile device may be determined to be in a mission-based shopping state if the mobile device associated with the user is found to be spend a predetermined period of time near the geolocation of a mobile sales associate based on the geolocation of both the sales associate and the mobile device.

For example, if it is determined that the shopping state of the user is a mission-based shopping state, the user may be provided with a listing of products associated with the location(s) the user visited. For example, if the user stopped at a clothing store in a mission-based shopping state, the listing of products may be clothing products such as, for example, clothing products from the stores the user visited or from comparable stores.

A discovery-based shopping state of a user may be indicated by a user moving randomly, slowly, or some combination thereof between more than a few points of interest. For example, a user in a discovery-based shopping state may be interested in window shopping or casually perusing a number of items. Such a user may have a mission to purchase one or more times, yet may window shop and/or casually peruse items as they shop for these one or more items.

A discovery-based shopping state can be determined, for example, based on the speed of the mobile device 105 as the user moves between points of interest. For example, if the mobile device 105 moves at speed that is less than the average walking speed of the user or the average walking speed of a shopper in the specific location then the user may be considered to be in a discovery-based shopping state.

A discovery-based shopping state may also be determined, for example, based on the number of times the mobile device 105 stops for a period of time at a point of interest. For example, a user may be in a discovery-based shopping state if the user stops at a number of points of interest such as, for example, more than four points of interest, five points of interest, or six points of interest in a given period of time, in a general geographical area, or some combination thereof.

As another example, if it is determined that the shopping state of the user is a discovery-based shopping state, the user may be provided with a listing of products associated with a variety of products or advertisements related to the user's demographics, transaction history, location, movement, speed, direction, or some combination thereof.

A research-based shopping state may be indicated by a user moving between back and forth between a few locations. For example, a user may be comparing necklaces at two different stores. While comparing these items the user may move back and forth between the two stores a number of times to compare the products.

A research-based shopping state can be determined, for example, based on geolocation information indicating that the mobile device 105 stopped for a period of time at first location; then stopped for a period of time at a second, different location; and then stopped for a period of time back at the first location.

As yet another example, if it is determined that the shopping state of the user is a research-based shopping state, then the user can be provided with a listing of products associated with the location(s) the user visited. For example, if the user stopped at a jewelry store and returned later to the jewelry store, the listing of products may be jewelry products.

A herd-based shopping state may be indicated by a user standing in a line or a crowded area for a long period of time or based on a movement of the user in a manner similar to a plurality of other users in the same or near the same location. For example, a user may be standing in a line with a large number of other people at or near a point of interest.

A herd-based shopping state can be determined, for example, based on geolocation information indicating that the user is moving very slowly for a period of time such as, for example, less than 1 mph or less than 0.5 mph for a period of time greater than 5 minutes, 10 minutes or 15 minutes.

A herd-based shopping state can be determined, for example, based on geolocation information indicating that the mobile device 105 is moving in the same direction and/or at the same rate as other mobile devices 105 in the nearby geolocation for a period of time such as, for example, a period of time greater than 5 minutes, 10 minutes or 15 minutes.

As another example, if it is determined that the shopping state of the user is a herd-based shopping state, then the user can be provided with a listing of products associated with the direction and/or location of the herd. For example, if the users are moving toward a store that is offering televisions for sale, the user can be presented with listing of televisions on their mobile device 105.

The average walking speed of a shopper may, for example, be a speed greater than 3.0 mph. The average walking speed of the user may the average walking speed the user moves as recorded by the mobile device 105. This average walking speed of the user may, for example, only measure the speeds when the user is considered to be walking such as, for example, speeds between 2.0 mph and 5.0 mph. The average walking speed of a shopper in the specific location may include a measure of the average walking speed of some of the other individuals in the specific area during the time period or during any time period.

A mobile device 105 may be considered stopped for a period of time at a point of interest if the mobile device 105 has a speed less than 0.5 mph for a period of time such as, for example, a period of time of more than 2 minutes, 5 minutes, 10 minutes, etc.

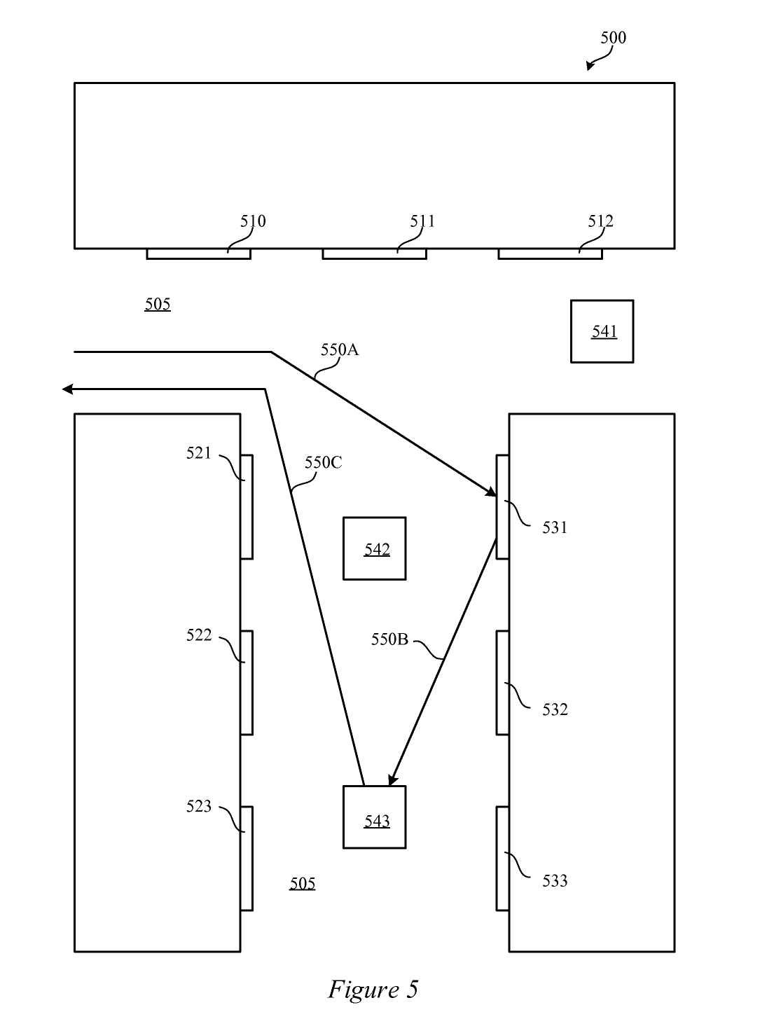

FIG. 5 illustrates an example path of a user in a mission-based shopping state moving through a shopping area 500 according to some embodiments described herein. The figure illustrates a top view of a shopping area 500 such as, for example, a mall or a street lined with stores. The shopping area 500 includes a plurality of points of interest 510, 511, 512, 521, 522, 523, 531, 532, 533, 541, 542, and 543. The plurality of stores and the plurality of kiosks are arranged around and/or within a thoroughfare 505 such as a walkway, a hallway, a road, a pedestrian mall, a street, an outdoor mall, an indoor mall, a strip mall, a public area, the interior of a store, or some combination thereof. The points of interest may include stores, store fronts, kiosks, product locations within a store, product displays, product hangers or racks, information desks, or some combination thereof. The points of interest may be separately owned stores, departments within a store, or some combination thereof.

The path illustrates an example path of a mobile device 105 used by a user in a mission-based shopping state through the shopping area. The path shows the trajectory of the mobile device 105 as its user walks through the thoroughfare 505. The path has three sub-paths: sub-path 550A showing the mobile device 105 approaching point of interest 531; sub-path 550B illustrating the mobile device 105 moving from point of interest 531 to point of interest 543; and sub-path 550C illustrating the mobile device 105 leaving point of interest 543.

The path may represent a mission-based shopping state of the user because the user's movements are direct and the user visits a few points of interest. In this example, the user moved directly to point of interest 531 and then directly to point of interest 543. Moreover, over the course of the path, the user only moves between two points of interest. Furthermore, the speed of the mobile device as it moves along the path shown in in FIG. 5 may indicate that the user is in a mission-based shopping state.

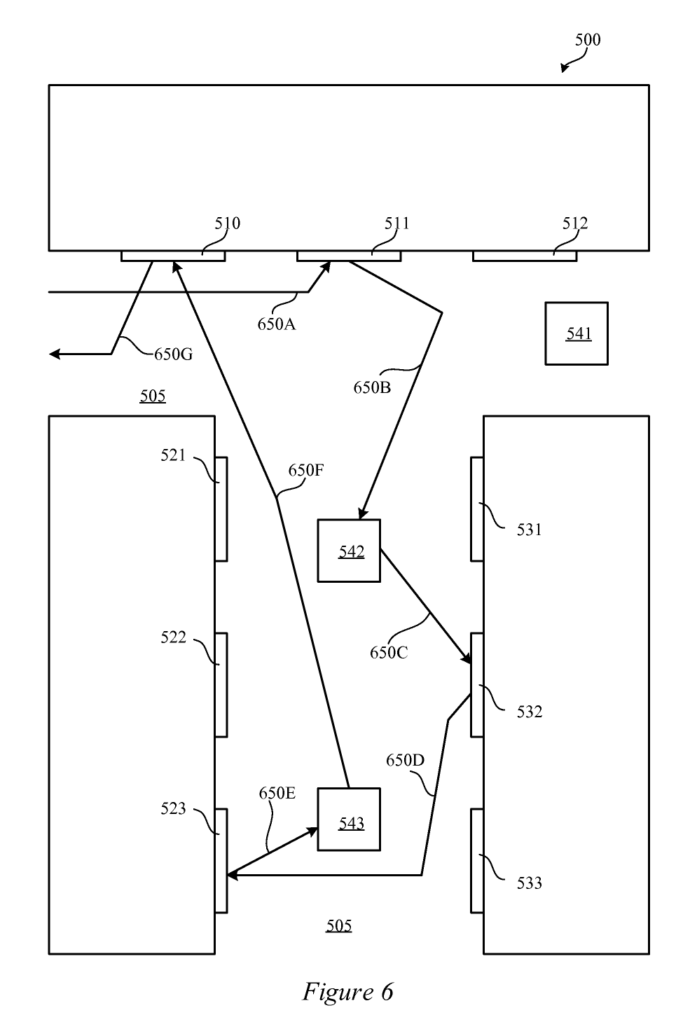

FIG. 6 illustrates an example path of a user in a discovery-based shopping state moving through the shopping area 500 according to some embodiments described herein. The figure illustrates an example path of a mobile device 105 used by a user in a discovery-based shopping state through the shopping area 500. The path shows the trajectory of the mobile device 105 as its user walks through the thoroughfare 505. The path has many sub-paths: sub-path 650A showing the mobile device 105 approaching point of interest 511; sub-path 650B illustrating the mobile device 105 moving from point of interest 511 to point of interest 542; sub-path 650C illustrating the mobile device 105 moving from point of interest 542 to point of interest 532; sub-path 650D illustrating the mobile device 105 moving from point of interest 532 to point of interest 523; sub-path 650E illustrating the mobile device 105 moving from point of interest 523 to point of interest 543; sub-path 650F illustrating the mobile device 105 moving from point of interest 543 to point of interest 510; and sub-path 650G illustrating the mobile device 105 leaving point of interest 510.

The path may represent a discovery-based shopping state of the user because the movement of the mobile device 105 is not always in a direct line between stores. In this example, the mobile device 105 stops for a period of time at several points of interest. Moreover, the path may represent a discovery-based shopping state of the user because the mobile device 105 stops for a period of time at a number of different points of interest.

As discussed above, a discovery-based shopping state may also be determined based on the speed of the mobile device 105 as it moves through thoroughfare 505.

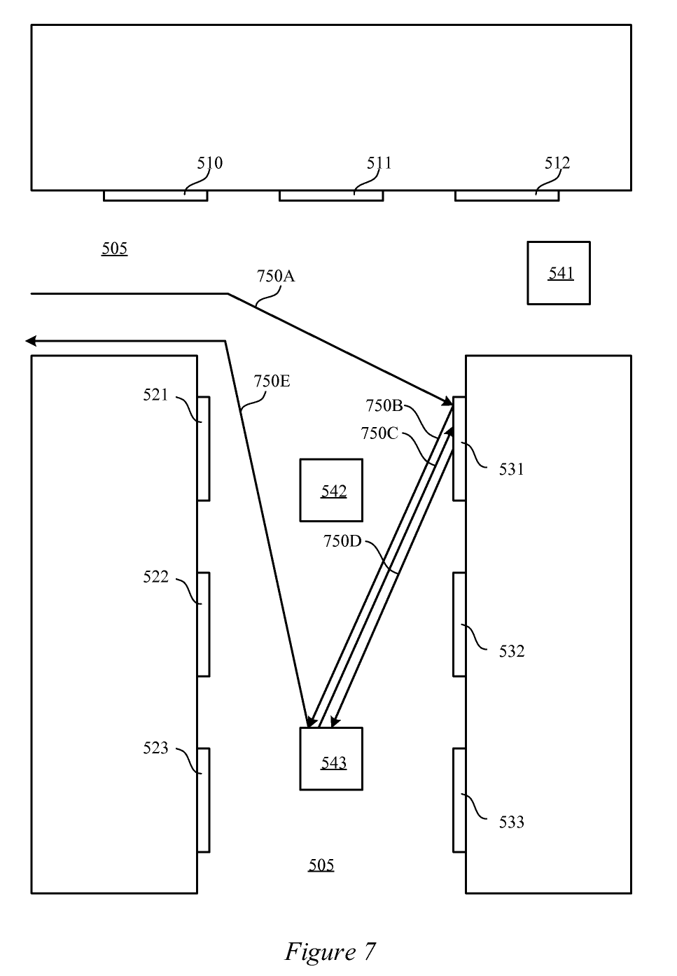

FIG. 7 illustrates an example path of a user in a research-based shopping state moving through the shopping area 500 according to some embodiments described herein.

The figure illustrates an example path of a mobile device 105 used by a user in a research-based shopping state through the shopping area 500. The path shows the trajectory of the mobile device 105 as its user walks through the thoroughfare 505. The path has many sub-paths: sub-path 750A showing the mobile device 105 approaching point of interest 531; sub-path 750B illustrating the mobile device 105 moving from point of interest 531 to point of interest 543; sub-path 750C illustrating the mobile device 105 moving from point of interest 543 to point of interest 531; sub-path 750D illustrating the mobile device 105 moving from point of interest 531 to point of interest 543; and sub-path 750E illustrating the mobile device 105 leaving point of interest 543.

The path shown in FIG. 7 may represent a research-based shopping state of the user because the movement of the mobile device 105 indicates that the user moved back and forth between point of interest 531 and point of interest 543. While the path in FIG. 7 shows the mobile device 105 moving back and forth multiple times between point of interest 531 and point of interest 543, in some embodiments, the path may indicate that the user returned to a single point of interest more than once and stopped for a predetermined period of time during both the first and the later stops.

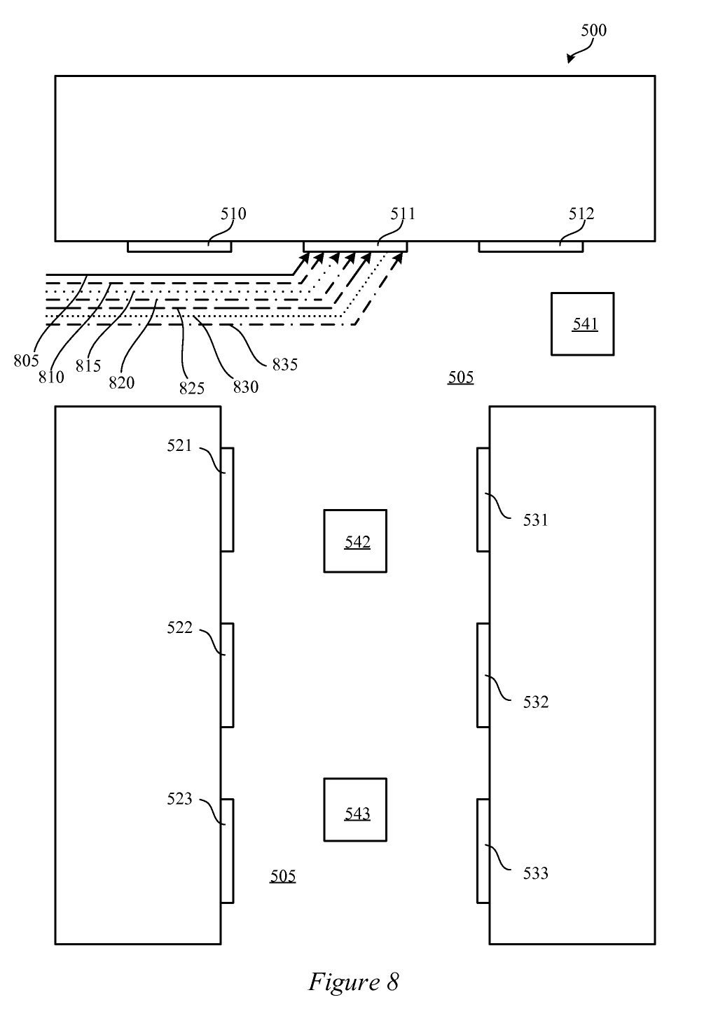

FIG. 8 illustrates an example path of a user in a herd-based shopping state moving through the shopping area 500 according to some embodiments described herein. The figure illustrates an example path 805 of a mobile device 105 used by a user in a herd-based shopping state through the shopping area 500. The path 805 shows the trajectory of the mobile device 105 as its user walks through the thoroughfare 505 toward point of interest 511. Six other users are also walking in the same thoroughfare 505 along paths 810, 815, 820, 825, 830, and 835. The paths 810, 815, 820, 825, 830, and 835 parallel the path 805 or nearly parallel the path 805. The paths 810, 815, 820, 825, 830, and 835 show mobile devices 105 the move toward the point of interest 511. It can be determined that the user of the mobile device 105 following the path 805 is in a herd-based shopping state by noting that a plurality of users are following paths 810, 815, 820, 825, 830, and 835 that are similar to path 805.

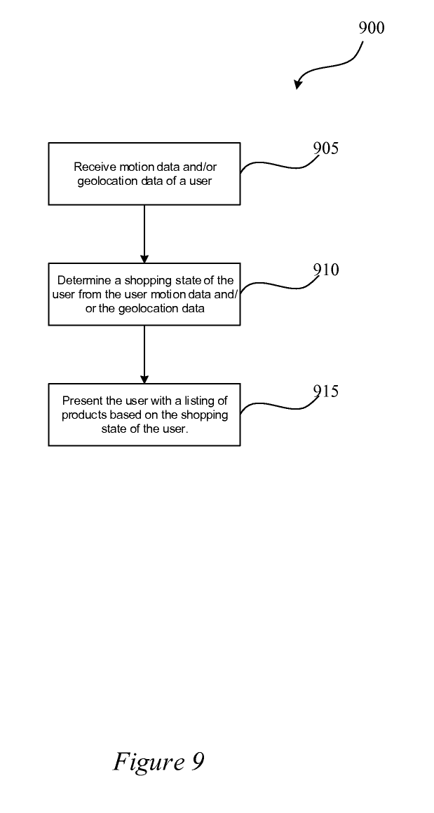

FIG. 9 is a flowchart of an example process 900 of using the shopping state of a user to provide a listing of products on a mobile device according to at least one embodiment described herein. One or more steps of the process 900 may be implemented, in some embodiments, by one or more components of server 135 of FIG. 1 or mobile device 105 of FIG. 1. Although illustrated as discrete blocks, various blocks may be divided into additional blocks, combined into fewer blocks, or eliminated, depending on the desired implementation.

Process 900 begins at block 905. Movement data such as motion data, geolocation data, or some combination thereof may be received. For example, the server 135 of FIG. 1 may receive this movement data from mobile device 105 through network 125. In some embodiments, the movement data may be received at an application, app, module, or some combination thereof executing on the mobile device 105. The movement data may include, for example, motion data collected from motion sensor 230. The movement data may also include, for example, geolocation data collected from GPS device 240. The movement data may also include, for example, data from the radio antenna 110, the Wi-Fi hotspot 115, a Bluetooth beacon, or some combination thereof that indicates the motion of the mobile device 105 relative to one or more of these devices.

In some embodiments, the movement data may include a time series of location data, acceleration data, speed data, direction data, or some combination thereof. In some embodiments, speed data and/or direction data may be derived from the movement data and/or stored with the movement data.

In some embodiments, the speed of the mobile device 105 can be determined from the movement data. In some embodiments, the amount of time the user of the mobile device 105 is stopped at particular locations can be determined. In some embodiments, the number of times the user of the mobile device 105 returns to a particular location can be determined from the movement data. In some embodiments, the directness of the user's path can be determined. In some embodiments the direction the mobile device 105 is heading may be determined.

At block 910, a shopping state of the user of the mobile device 105 may be determined based on the speed of the mobile device 105, the number of times the user of the mobile device 105 returns to a particular location, the amount of time the user of the mobile device 105 is stopped at particular locations, the directness of the user's path, the direction the mobile device is heading, the acceleration of the mobile device, or some combination thereof may be used to determine the shopping state of the user of the mobile device 105. In some embodiments, at block 910 the state of the user may include a non-shopping state of the user such as, for example, whether the user is inebriated, sleepy, impaired, or medicated.

At block 915 the user can be presented with a listing of products on the mobile device 105 based on the shopping state of the user. A listing of products may be selected from the product listing database 150 as shown in FIG. 1 and FIG. 4.

In some embodiments, the listing of products provided to the user may be further defined by a user's profile such as, for example, the user profile associated with the user ID 320, the user information 330, or some combination thereof as shown in FIG. 3. This user information may include the shopping habits of the user, the demographics of the user, etc.

In some embodiments, block 915 may be replaced with presenting the user with one or more advertisements based on the shopping state of the user. Advertisements may be selected from the advertisement database 155 as shown in FIG. 1 and FIG. 4.

For example, if the user stopped at a clothing store in a mission-based shopping state, the advertisement may be for clothing products such as, for example, clothing products from the stores the user visited or from comparable stores.

As another example, if it is determined that the shopping state of the user is a discovery-based shopping state, the user may be provided with an advertisement for products associated with factors related to the demographics of the user, the location of the user, the time of year, etc., or some combination thereof.

If it is determined that the shopping state of the user is a herd-based shopping state, then the user can be provided with an advertisement associated with the direction and/or location of the herd. For example, if the user and the herd are moving toward a store that is offering televisions for sale, the user can be presented with an advertisement for televisions on their mobile device 105.

As yet another example, if it is determined that the shopping state of the user is a research-based shopping state, then the user can be provided with an advertisement associated with the location(s) the user visited. For example, if the user stopped at a jewelry store and returned later to the jewelry store, the advertisement may be for jewelry products.

In some embodiments, the listing of products provided to the user may be further defined by a user's profile such as, for example, the user profile associated with the user ID 320, the user information 330, or some combination thereof as shown in FIG. 3. This user information may include the shopping habits of the user, the demographics of the user, etc.

In some embodiments, at block 915 the rather than presenting user with a product listing or an advertisement based on the shopping state of the user, the user interface of an application executing on mobile device 105 may be changed or modified or the information provided to a user may be changed or modified based on the shopping state of the user or another state of the user that is determined based on the movement data.

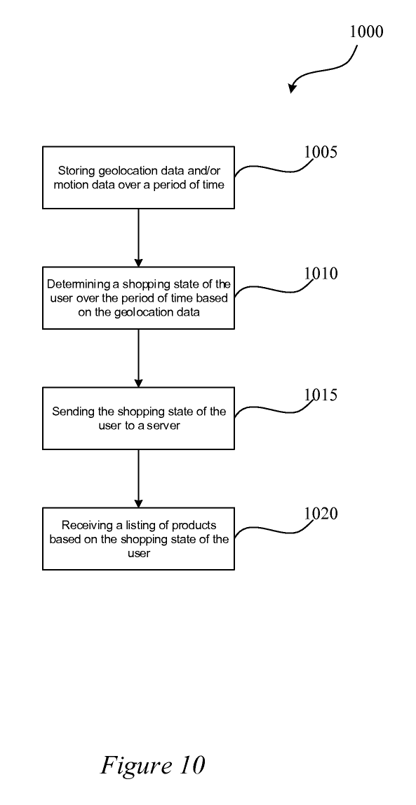

FIG. 10 is a flowchart of an example process 1000 of using the shopping state of a user to provide a listing of products on a mobile device according to at least one embodiment described herein. One or more steps of the process 1000 may be implemented, in some embodiments, by the mobile device 105 of FIG. 1. Although illustrated as discrete blocks, various blocks may be divided into additional blocks, combined into fewer blocks, or eliminated, depending on the desired implementation.

At block 1005 geolocation data and/or motion data may be recorded and stored by the mobile device 105. In some embodiments, the geolocation data and/or motion data may be recorded while the mobile device 105 is located at or near a shopping area. For example, using map data such as, for example, from maps 214, and/or a map application, an application or module on the mobile device 105 may determine using GPS data that the mobile device 105 is at or near a shopping area. The application or module on the mobile device 105 may include information defining boundaries on a map specifying the locations of shopping areas.

In some embodiments, the geolocation data and/or motion data may be recorded at a predetermined frequency such as, for example, at 1 kHz, 0.1 kHz, 0.5 kHz, 0.01 kHz, etc. In some embodiments, an application or module on the mobile device 105 may be programmed to record the geolocation data and/or motion data at the predetermined frequency.

At block 1010 the shopping state of the user using the mobile device 105 may be determined based on the motion data. In some embodiments, a module or application executing on the mobile device 105 may determine the shopping state of the user. In some embodiments, the shopping state may include any shopping state or other state of the user as described herein.

At block 1015 the shopping state of the user may be sent from the mobile device 105 to the server 135. In response, the server 135 may select a listing of products to display to the user based on the shopping state of the user. Additionally or alternatively, the server 135 may select one or more advertisements based on the shopping state of the user.

At block 1020 the mobile device 105 may receive the listing of products and/or the one or more advertisements. The listing of products or the one or more advertisements can be transmitted in a number of different ways. For example, the server 135 may produce a webpage that includes the listing of the products and/or the one or more advertisements. The server 135 may transmit a link or the address where the webpage may be downloaded. The mobile device 105 may then fetch the webpage from the address associated with the link or the address sent from the server 135, and displays the webpage with the listing of products and/or the one or more advertisements.

In some embodiments, the listing of products provided to the user may be further defined by a user's profile such as, for example, the user profile associated with the user ID 320, the user information 330, or some combination thereof as shown in FIG. 3. This user information may include the shopping habits of the user, the demographics of the user, etc.

In some embodiments, block 1020 may be replaced with presenting the user with one or more advertisements based on the shopping state of the user. Advertisements may be selected from the advertisement database 155 as shown in FIG. 1 and FIG. 4.

For example, if the user stopped at a clothing store in a mission-based shopping state, the advertisement may be for clothing products such as, for example, clothing products from the stores the user visited or from comparable stores.

As another example, if it is determined that the shopping state of the user is a discovery-based shopping state, the user may be provided with an advertisement for products associated with factors related to the demographics of the user, the location of the user, the time of year, etc., or some combination thereof.

If it is determined that the shopping state of the user is a herd-based shopping state, then the user can be provided with an advertisement associated with the direction and/or location of the herd. For example, if the user and the herd are moving toward a store that is offering televisions for sale, the user can be presented with an advertisement for televisions on their mobile device 105.

As yet another example, if it is determined that the shopping state of the user is a research-based shopping state, then the user can be provided with an advertisement associated with the location(s) the user visited. For example, if the user stopped at a jewelry store and returned later to the jewelry store, the advertisement may be for jewelry products.

In some embodiments, the listing of products provided to the user may be further defined by a user's profile such as, for example, the user profile associated with the user ID 320, the user information 330, or some combination thereof as shown in FIG. 3. This user information may include the shopping habits of the user, the demographics of the user, etc.

As another example, the server 135 may send a unique link or address associated with a listing for each product and/or an advertisement. The mobile device 105 may then fetch one more listing of products and/or the advertisement. The mobile device 105 may also display one or more of the listing of products and/or the advertisement.

In some embodiments, information specifying the listing of products and/or the advertisement may be sent to a third party server. The third party server may create a webpage from this information and may send the webpage to the mobile device 105.

Some embodiments of the present disclosure include, for example, a method that may be used for inferring the state of a user of a mobile device based on the movement of the mobile device. A method is provided that includes receiving, at a computer system, movement data from a mobile device through a network interface, the movement data comprising data specifying the movement of the mobile device over a period of time; determining, at the computer system, a shopping state of a user of the mobile device based on the movement data; selecting a plurality of products from a database of available products to present to the user based on the shopping state of the user, and providing, through the network interface, a listing of the plurality of products to the mobile device.

In some embodiments, the method may include creating a displayable page that comprises the listing of the plurality of product that when rendered by an application on the mobile device displays a viewable listing of the plurality of products.

In some embodiments, the shopping state may be determined based on a geolocation factor selected from the list consisting of: the number of times the mobile device is at rest for longer than a predetermined period of times, the speed of the mobile device, and the direction of the mobile device.

In some embodiments, the method may further comprise receiving, at the computer system, geolocation data from the mobile device; and determining a store type based on the geolocation data. In some embodiments, the selecting the plurality of products from a database of available products includes selecting the plurality of products based on the store type.

In some embodiments, the shopping state may include a discovery-based shopping state when the movement data comprises an average speed that is less than the average walking speed of the user. In some embodiments, the shopping state may include a mission-based shopping state when the movement data comprises an average speed that is greater than the average walking speed of the user. In some embodiments, the shopping state may include a herd-based shopping state when the movement data comprises movement data consistent with movement data of a plurality of other mobile devices at the same geolocation. In some embodiments, the shopping state may include a research-based shopping state when the movement data comprises data specifying that the mobile device spent a first period of time at rest at a first geolocation, a second period of time at any geolocation other than the first geolocation, and a third period of time at rest at the first geolocation.

In some embodiments, the method may further comprise determining whether the movement data corresponds with a geolocation at or near a store; and disregarding the movement data that does not correspond with a geolocation at or near a store.

Another method is provided that may include collecting geolocation data of a mobile device over a period of time; deriving speed data and direction data of the mobile device over the period of time from the geolocation data; determining a state of a user of the mobile device based on the speed data and the direction data; and modifying a user interface of the mobile device based on the state of the user of the mobile device.

In some embodiments, the modifying a user interface of the mobile device based on the state of the user of the mobile device comprises displaying a listing of products that are selected based on the state of the user of the mobile device. In some embodiments, the modifying a user interface of the mobile device based on the state of the user of the mobile device comprises changing a user interface of one or more applications based on the stat of the user of the mobile device. In some embodiments, the modifying a user interface of the mobile device based on the state of the user of the mobile device comprises displaying one or more advertisements that are selected based on the state of the user of the mobile device.

In some embodiments, the state of the user of the mobile may be a discovery-based shopping state when an average speed of the mobile device is less than the average walking speed of the user. In some embodiments, the state of the user of the mobile may be a mission-based shopping state when an average speed of the mobile device is greater than the average walking speed of the user. In some embodiments, the state of the user of the mobile may be research-based shopping state when the movement data comprises data specifying that the mobile device spent a first period of time at rest at a first geolocation, a second period of time at any geolocation other than the first geolocation, and a third period of time at rest at the first geolocation. In some embodiments, the state of the user of the mobile may be an inebriated state, a sleepy state, an impaired state, or a medicated state when the movement data comprises data specifying that the mobile device is undergoing rapid or unusual changes in speed and/or direction that may suggest an impaired state of the user.

In some embodiments, the method may include sending the state of the user of the mobile device to a server, receiving data to present to the user through a user interface; and displaying the data on the user interface.

A mobile device is also provided according to some embodiments described herein, that includes means for collecting geolocation data; means for deriving either or both speed data and direction data of the mobile device from the geolocation data; means for deriving a state of a user of the mobile device from either or both the speed data and the direction data; and means for displaying information to the user based on the state of the user of the mobile device. In some embodiments, the state of the user may include a shopping state of the user and the information comprises product information.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing art to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared, or otherwise manipulated. It has proven convenient at times, principally for reasons of common usage, to refer to such signals as bits, data, values, elements, symbols, characters, terms, numbers, numerals, or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical, electronic, or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for-purposes of example rather than limitation, and does not preclude inclusion of such modifications, variations, and/or additions to the present subject matter as would be readily apparent to one of ordinary skill in the art.

That which is claimed:

1. A method comprising:
collecting geolocation data of a mobile device over a period of time;
deriving speed data and direction data of the mobile device over the period of time from the geolocation data;
determining a state of a user of the mobile device based on the speed data and the direction data; and
modifying a user interface of the mobile device based on the state of the user of the mobile device.

2. The method according to claim 1, wherein the modifying a user interface of the mobile device based on the state of the user of the mobile device comprises displaying a listing of products that are selected based on the state of the user of the mobile device.

3. The method according to claim 1, wherein the modifying a user interface of the mobile device based on the state of the user of the mobile device comprises changing a user interface of one or more applications based on the stat of the user of the mobile device.

4. The method according to claim 1, wherein the modifying a user interface of the mobile device based on the state of the user of the mobile device comprises displaying one or more advertisements that are selected based on the state of the user of the mobile device.

5. The method according to claim 1, wherein the determining the state of the user of the mobile comprises determining a discovery-based shopping state when an average speed of the mobile device is less than an average walking speed of the user.

6. The method according to claim 1, wherein the determining the state of the user of the mobile comprises determining a mission-based shopping state when an average speed of the mobile device is greater than an average walking speed of the user, and wherein the average walking speed of the user is based on previously collected data relating to the user.

7. The method according to claim 1, wherein the determining the state of the user of the mobile comprises determining a research-based shopping state when movement data comprises data specifying that the mobile device spent a first period of time at rest at a first geolocation, a second period of time at any geolocation other than the first geolocation, and a third period of time at rest at the first geolocation.

8. The method according to claim 1, wherein the determining the state of the user of the mobile device comprises determining an inebriated state, a sleepy state, an impaired, or a medicated state when movement data comprises data specifying that the mobile device is undergoing rapid changes in speed and/or direction.

9. The method according to claim 1, further comprising:
sending the state of the user of the mobile device to a server,
receiving data to present to the user through a user interface; and
displaying the data on the user interface.

10. A mobile device comprising:
means for collecting geolocation data;
means for deriving either or both speed data and direction data of the mobile device from the geolocation data;
means for deriving a state of a user of the mobile device from either or both the speed data and the direction data; and
means for displaying information to the user based on the state of the user of the mobile device.

11. The mobile device according to claim 10, wherein the state of the user comprises a shopping state of the user and the information comprises product information.

12. A computer-readable medium having instructions stored thereon that are executable, by a machine, to cause the machine to perform operations comprising:
receiving, at a computer system through a network interface, movement data from a mobile device, the movement data comprising data specifying the movement of the mobile device over a period of time;
determining, at the computer system, a shopping state of a user of the mobile device based on the movement data;
selecting a plurality of products from a database of available products to present to the user based on the shopping state of the user, and
providing, through the network interface, a listing of the plurality of products to the mobile device.

13. The method according to claim 12, the operations further comprising:
creating a displayable page that comprises the listing of the plurality of product that when rendered by an application on the mobile device displays a viewable listing of the plurality of products.

14. The method according to claim 12, wherein the shopping state is determined based on a geolocation factor selected from the list consisting of: a number of times the mobile device is at rest for longer than a predetermined period of times, a speed of the mobile device, and a direction of the mobile device.

15. The method according to claim 12, the operations further comprising:
receiving, at the computer system, geolocation data from the mobile device; and
determining a store type based on the geolocation data;
wherein the selecting the plurality of products from a database of available products includes selecting the plurality of products based on the store type.

16. The method according to claim 12, wherein the shopping state comprises a discovery-based shopping state when the movement data comprises an average speed that is less than the average walking speed of the user.

17. The method according to claim 12, wherein the shopping state comprises a mission-based shopping state when the movement data comprises an average speed that is greater than the average walking speed of the user.

18. The method according to claim 12, wherein the shopping state comprises a herd-based shopping state when the movement data comprises movement data consistent with movement data of a plurality of other mobile devices at the same geolocation.

19. The method according to claim 12, wherein the shopping state comprises a research-based shopping state when the movement data comprises data specifying that the mobile device spent a first period of time at rest at a first geolocation, a second period of time at any geolocation other than the first geolocation, and a third period of time at rest at the first geolocation.

20. The method according to claim 12, the operations further comprising:
determining whether the movement data corresponds with a geolocation at or near a store; and
disregarding the movement data that does not correspond with a geolocation at or near a store.
